(19) United States
(12) Patent Application Publication
(10) Pub. No.: US 2020/0191577 A1
(43) Pub. Date: Jun. 18, 2020

(54) METHOD AND SYSTEM FOR ROAD IMAGE RECONSTRUCTION AND VEHICLE POSITIONING

(71) Applicant: Industrial Technology Research Institute, Hsinchu (TW)

(72) Inventor: Che-Tsung Lin, Hsinchu City (TW)

(73) Assignee: Industrial Technology Research Institute, Hsinchu (TW)

(21) Appl. No.: 16/223,046

(22) Filed: Dec. 17, 2018

(30) Foreign Application Priority Data
Dec. 14, 2018 (TW) 107145184

(51) Int. Cl. G01C 21/32; G06K 9/00; G06T 7/32; G06T 7/70

(52) U.S. Cl. CPC G01C 21/32; G06K 9/00798; G06T 2207/30244; G06T 7/70; G06T 2207/30256; G06T 7/32

(57) ABSTRACT

The disclosure relates to a method for road image reconstruction and a system thereof. The method for road image reconstruction includes: a capturing step, capturing an image Iₜ₋ₙ at time t-n and an image Iₜ at time t, the image Iₜ₋ₙ at time t-n and the image Iₜ at time t including identical road surface pixels and different road surface pixels; an analyzing step, analyzing the image Iₜ₋ₙ at time t-n and the image Iₜ at time t to obtain a plurality of feature correspondences; an estimating step, estimating a geometric relationship between the image Iₜ₋ₙ at time t-n and the image Iₜ at time t from the feature correspondences; and a stitching step, stitching the image Iₜ₋ₙ at time t-n and the image Iₜ at time t into a complete road image Iₜ₋ₙ, t according to the geometric relationship of the feature correspondences, and distances between the identical road surface pixels and the different road surface pixels in the image Iₜ₋ₙ at time t-n and the image Iₜ at time t. The road image reconstruction system includes an image capturing device and a processing unit. The image capturing device captures images, and the processing unit performs the steps in the road image reconstruction method other than image capture. The disclosure also relates to a vehicle positioning method and a system generating complete road images by applying the road image reconstruction method and the system thereof.

### CROSS-REFERENCE TO RELATED APPLICATION

This application claims the priority benefit of Taiwan application serial no. 107145184, filed on Dec. 14, 2018. The entirety of the above-mentioned patent application is hereby incorporated by reference herein and made a part of this specification.

### TECHNICAL FIELD

The disclosure relates to methods and systems for image reconstruction and positioning, and more particularly, relates to methods and systems for road image reconstruction and vehicle positioning.

### BACKGROUND

In theory, self-driving vehicles nowadays can run smoothly in general weather conditions. However, the global positioning system (GPS) signal can be occluded easily so its positioning accuracy is affected accordingly, resulting in inaccurate positioning for the self-driving vehicles. Road markings (such as traffic markings or line markings) can be used as important sources of positioning information provided for the self-driving vehicle to relocate its own location in a small range. Nonetheless, the road markings may also be occluded by other vehicles or objects, making it hard to identify the road markings, and causing deviations between the vehicle positioning and the navigation for the self-driving vehicles.

### SUMMARY

The disclosure provides a method and a system for road image reconstruction to thereby generate a complete road image not occluded by other objects for use in a subsequent road marking identification.

According to an embodiment of the disclosure, a road image reconstruction method is provided and includes: a capturing step, capturing an image Iₜ₋ₙ at time t-n and an image Iₜ at time t, the image Iₜ₋ₙ at time t-n and the image Iₜ at time t including identical road surface pixels and different road surface pixels; an analyzing step, analyzing the image Iₜ₋ₙ at time t-n and the image Iₜ at time t to obtain a plurality of feature correspondences; an estimating step, estimating a geometric relationship between the image Iₜ₋ₙ at time t-n and the image Iₜ at time t from the feature correspondences; and a stitching step, stitching the image Iₜ₋ₙ at time t-n and the image Iₜ at time t into a complete road image Iₜ₋ₙ, t according to the geometric relationship, and distances between the identical road surface pixels comparing to the different road surface pixels in the image Iₜ₋ₙ at time t-n and the image Iₜ at time t.

According to another embodiment of the disclosure, a road image reconstruction system is provided and includes an image capturing device and a processing unit. The image capturing device captures images, and the processing unit performs the steps in the road image reconstruction method except for image capture.

The disclosure also provides a method and a system for vehicle positioning to thereby deduce an exact location of a vehicle in a map file through multiple sources of information, including road markings identified in a complete road image, map files in a map system and coordinates of a global positioning system.

According to yet another embodiment of the disclosure, a vehicle positioning method is provided for positioning a vehicle having an image capturing, and the vehicle positioning method includes: a capturing step, capturing an image Iₜ₋ₙ at time t-n and an image Iₜ at time t, the image Iₜ₋ₙ at time t-n and the image Iₜ at time t including identical road surface pixels and different road surface pixels; an analyzing step, analyzing the image Iₜ₋ₙ at time t-n and the image Iₜ at time t to obtain a plurality of feature correspondences; an estimating step, estimating a geometric relationship between the image Iₜ₋ₙ at time t-n and the image Iₜ at time t from the feature correspondences; a stitching step, stitching the image Iₜ₋ₙ at time t-n and the image Iₜ at time t into a complete road image Iₜ₋ₙ, t according to the geometric relationship, and distances between the identical road surface pixels and the different road surface pixels in the image Iₜ₋ₙ at time t-n and the image Iₜ at time t; an identifying step, detecting and identifying a road marking in the complete road image I_{t-n, t}; a measuring step, estimating a distance from the road marking to the vehicle; a comparing step, comparing the road marking in the complete road image I_{t-n, t} with road marking information in a map file; and a positioning step, deducing an exact location of the vehicle in the map file according to the distance obtained in the measuring step, a comparison result of the road marking obtained in the comparing step, and a potential location of the vehicle provided by a global positioning system.

According to an embodiment of the disclosure, a vehicle positioning system is provided for positioning a vehicle. The system includes a global position system, a map system, an image capturing device and a processing unit. The global positioning system provides a potential location of the vehicle. The map system includes a map file including road marking information. The image capturing device captures images. The processing unit performs the steps in the road vehicle positioning method other than image capture.

Based on the above, with the road image reconstruction of the disclosure, a complete road image not occluded by other objects is generated, and the accurately positioning of the vehicle may be achieved along with use of related information of the map system and the global positioning system.

To make the above features and advantages of the disclosure more comprehensible, several embodiments accompanied with drawings are described in detail as follows.

### BRIEF DESCRIPTION OF THE DRAWINGS

FIG. 1 is a flowchart of methods for road image reconstruction and vehicle positioning according to an embodiment of the disclosure.

FIG. 2 is a block diagram of systems for road image reconstruction and vehicle positioning according to an embodiment of the disclosure.

FIG. 3A is a schematic diagram of a front view image at time t-n captured by the image capturing device according to an embodiment of the disclosure.

FIG. 3B is a schematic diagram of a front view image at time t captured by the image capturing device according to an embodiment of the disclosure.

Part (A) of FIG. 4 is a schematic diagram of a bird view image at time t-n processed by the processing unit according to an embodiment of the disclosure.

Part (B) of FIG. 4 is a schematic diagram of a bird view image at time t processed by the processing unit according to an embodiment of the disclosure.

Part (C) of FIG. 4 is a schematic diagram of a complete road image reconstructed by the processing unit according to an embodiment of the disclosure.

### DETAILED DESCRIPTION

A description accompanied with embodiments and drawings is provided below to sufficiently explain the disclosure. However, it is noted that the disclosure may still be implemented in many other different forms and should not be construed as limited to the embodiments described hereinafter. For ease of explanation, same devices below are provided with same reference numerals. Although drawings are for the sake of clarity, various components and their respective sizes are not drawn to scale.

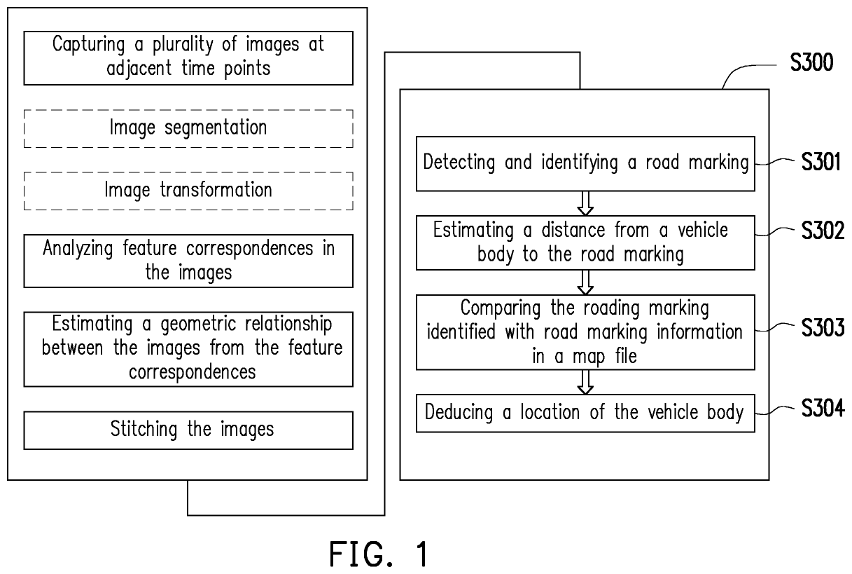

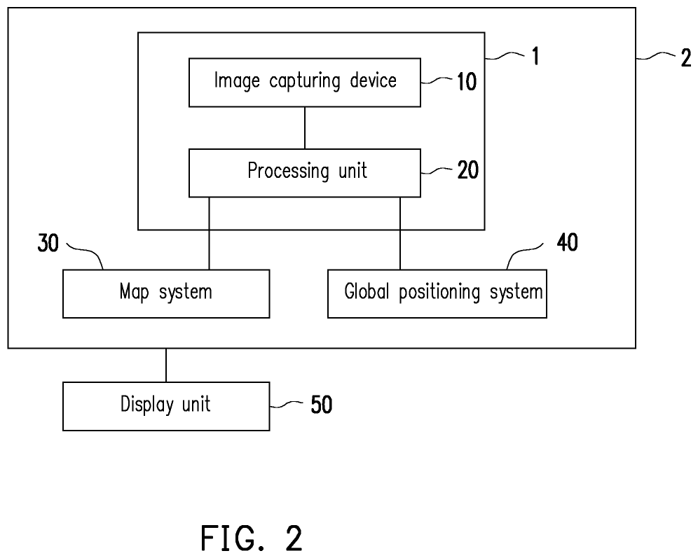

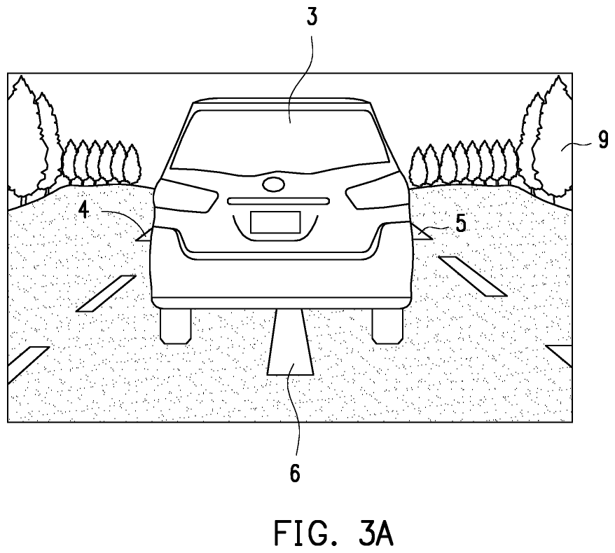

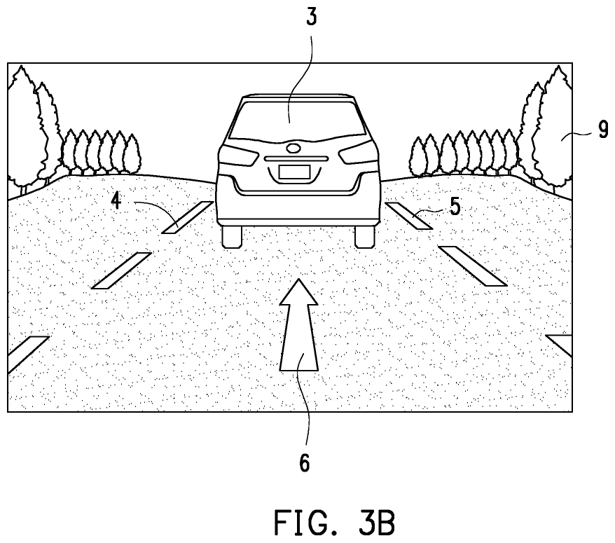

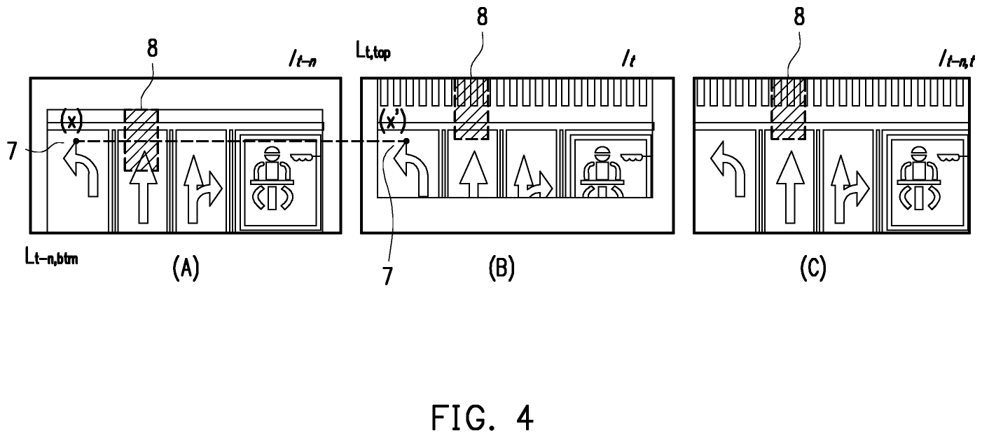

Please refer to FIG. 1, FIG. 2, FIG. 3A and FIG. 3B, and FIG. 4 together. FIG. 1 is a flowchart of a road image reconstruction and vehicle positioning method according to an embodiment of the disclosure. FIG. 2 is a block diagram of a road image reconstruction and vehicle positioning system according to an embodiment of the disclosure. FIG. 3A is a schematic diagram of a front view image at time t-n captured by the image capturing device according to an embodiment of the disclosure. FIG. 3B is a schematic diagram of a front view image at time t captured by the image capturing device according to an embodiment of the disclosure. Part (A) of FIG. 4 is a schematic diagram of a bird view image at time t-n processed by the processing unit according to an embodiment of the disclosure. Part (B) of FIG. 4 is a schematic diagram of a bird view image at time t processed by the processing unit according to an embodiment of the disclosure. Part (C) of FIG. 4 is a schematic diagram of a complete road image reconstructed by the processing unit according to an embodiment of the disclosure.

According to an embodiment of the disclosure, a road image reconstruction system 1 mainly includes an image capturing device 10 and a processing unit 20. The road image reconstruction system 1 is configured to perform a road image reconstruction step S100 (with detailed steps S101 to S106), which is described as follows.

First of all, in the step S101, the image capturing device 10 captures a plurality of different images at adjacent time points, such as an image Iₜ₋ₙ at time t-n and an image Iₜ at time t, from the same viewing angle. In a typical driving scenario, there may be other moving objects like vehicles or pedestrians in front of a vehicle equipped with the image capturing device 10 (will be referred to as “the vehicle body” in the following paragraphs). Accordingly, a road marking may be occluded in different ways in the images captured at different times. In other words, the image Iₜ₋ₙ at time t-n and the image Iₜ at time t includes identical road surface pixels and different road surface pixels. As shown by FIG. 3A, in the front view image at time t-n, since a vehicle 3 in front is close to the vehicle body (the vehicle 3 in front occupies a relatively large space of the image), a left lane line 4 and a right lane line 5 with respect to a lane are occluded by the vehicle 3 in front and an road marking 6 on the road is also partially occluded by the vehicle 3 in front so it is impossible to determine the instruction indicated by the road marking 6. As shown by FIG. 3B, in the front view image at time t, since the vehicle 3 in front is far from the vehicle body (the vehicle 3 in front occupies a relatively small space of the image), the left lane line 4 and the right lane line 5 with respect to the lane are not occluded by the vehicle 3 in front and the road marking 6 on the road is not occluded by the vehicle 3 in front either so it is possible to know the road marking 6 instructs to go forward; in other words, road marking 6 in the front view images at time t-n and time t are composed of different road surface pixels in the images at different times.

Next, in the step S102, an image segmentation may be performed for the image Iₜ₋ₙ at time t-n and the image Iₜ at time t, so that road surface pixels of a travelable region in the image Iₜ₋ₙ at time t-n and the image Iₜ at time t have a visual characteristic different from that of the other pixels. As shown by FIG. 3A and FIG. 3B, the road surface pixels of the travelable region and pixels of objects like the vehicle 3 in front and a tree 9 are covered by different color layers to thereby separate the road surface pixels of the travelable region from the other pixels of a non-travelable region. An algorithm of the image segmentation may adopt a deep learning-based model such as FCN (Fully Convolutional Network), Segnet etc., and may also adopt a non-deep learning-based model such as SS (Selective Search), as long as the road surface pixels of the travelable region in each image may be separated from the other pixels. Through the image segmentation, non-road surface pixels in the image Iₜ₋ₙ at time t-n and the image Iₜ at time t may be filtered out, and the road surface pixels of the travelable region may be kept for a subsequent reconstruction of the complete road image. This image segmentation step can improve subsequent processing performance. In another embodiment, it is possible that the road image reconstruction method does not include the step S102. In this case, as long as the images captured at different times include the road surface pixels, the subsequent reconstruction of the complete road image may then be performed.

Next, in the step S103, the image at different times may be transformed into bird view images, as shown by Part (A) of FIG. 4 to Part (C) of FIG. 4. In the bird view images, the road marking has scale invariance, which is beneficial to simplify a subsequent process for image analyzing. In another embodiment, it is also possible that the road image reconstruction method does not include the step S103. For example, the captured images may already be bird view images, or scale invariance of the road marking may be achieved by other technical means in subsequent process for image analyzing.

Next, in the step S104, the images at adjacent time points are analyzed to obtain feature correspondences among these images. Here, it should be noted that, as shown by Part (A) of FIG. 4 and Part (B) of FIG. 4, at different times, because the road marking in the middle lane is occluded by another vehicle 8 in different manners, the image Iₜ₋ₙ at time t-n and the image Iₜ at time t include identical and different road surface pixels. The step S104 is described in detail as follows. First, a plurality of features (e.g., corner points, edges or blocks) in each of a plurality of pairs of images at adjacent time points (the image Iₜ₋ₙ at time t-n shown by Part (A) of FIG. 4 and the image Iₜ at time t shown by Part (B) of FIG. 4) are found. Next, the features are compared between the image Iₜ₋ₙ at time t-n and the image Iₜ at time t to verify the feature correspondences in the images, such as a topmost corner point 7 on a left turn arrow on the leftmost lane shown in Part (A) of FIG. 4 and Part (B) of FIG. 4. For instance, the feature correspondences may be analyzed by adopting Scale-Invariant Feature Transform (SIFT) algorithm, Speeded Up Robust Features (SURF) algorithm, or other algorithms that can be used to obtain the feature correspondences between two images.

Next, in the step S105, a geometric relationship between the images is estimated according to the feature correspondences obtained in the previous step S104, and detailed practice regarding the same is provided as follows. First, a coordinate value of each of the feature correspondences at time t-n in the image Iₜ₋ₙ at time t-n may be defined as x, and a coordinate value of each of the feature correspondences at time t in the image Iₜ at time t may be defined as x′. Here, the coordinate values are expressed as homogenous coordinates, and a relationship between the two before and after the transformation is defined as x′=Hx, wherein H is a 3×3 matrix, which is used to describe the geometric relationship between the image Iₜ₋ₙ a time t-n and the image Iₜ at time t. The 3×3 matrix H may be solved by the coordinate values from several sets of the known feature correspondences. Specifically, in order to estimate 9 elements in this matrix H, four sets or more of the known feature correspondences are required. Next, a best solution of the 3×3 matrix H may be estimated by using the known feature correspondences together with, for example, Direct Linear Transformation (DLT) algorithm and Random Sample Consensus (RANSAC) algorithm. Once the 3×3 matrix H is determined, the coordinate value of any pixel (including the feature correspondence) in the image Iₜ at time t transformed from the image Iₜ₋ₙ at time t-n may then be obtained.

Next, in the step S106, according to what was obtained in step S105, the image Iₜ₋ₙ at time t-n and the image Iₜ at time t are stitched into a complete road image Iₜ₋ₙ, t in which the road marking is not occluded. Here, in order to make the stitched complete road image Iₜ₋ₙ, t seen more natural in this embodiment, the image Iₜ₋ₙ at time t-n and the image Iₜ at time t are stitched in a linear manner according to a stitch weight α. As shown by Part (A) of FIG. 4 to Part (C) of FIG. 4, a bottom border of the image Iₜ₋ₙ at time t-n is defined as L_{t-n, btm}; a top border of the image Iₜ at time t is defined as L_{t, top}; and the stitch weight α is defined as (y−L_{t, top})/(L_{t-n, btm}−L_{t, top}), wherein y denotes a coordinate of any road surface pixel in a Y direction. All the road surface pixels between the bottom border coordinate L_{t-n, btm} and the top border coordinate L_{t, top} are stitched through the following linear stitch function: I_{t-n, t}=αIₜ₋ₙ+(1−α) Iₜ. As can be known from the definitions of the stitch weight α and the stitch function, in this embodiment, in order to obtain the best image stitching result, the stitched image need to take into account distances between the identical road surface pixels and the different road surface pixels in the image Iₜ₋ₙ at time t-n and the image Iₜ at time t. In other words, the road surface pixels closer to the bottom border coordinate L_{t-n, btm} are mainly those presented in the image Iₜ₋ₙ at time t-n, whereas the road surface pixels closer to the top border coordinate L_{t, top} are mainly those presented in the image Iₜ at time t. If any road surface pixel is missing in the image at one specific time, the corresponding road surface pixel present in the image at another time would be used instead. Up to this step S106, the reconstruction of the complete road image I_{t-n, t} is completed.

The complete road image Iₜ₋ₙ, t obtained in aforementioned method may be further used for positioning the vehicle equipped with the image capturing device 10 (still referred to as “the vehicle body” in the following paragraphs). Brief description is provided below with reference to the road image reconstruction step S100 and a vehicle positioning step S300 in FIG. 1 and a vehicle positioning system 2 in FIG. 2. In this embodiment, the vehicle positioning system 2 may include the image capturing device 10, the processing unit 20, a map system 30 and a global positioning system (GPS) 40. The processing unit 20 in the vehicle positioning system 2 can perform a road marking detection and identification (a step S301) for the complete road image I_{t-n, t} in which the road marking is not occluded (e.g., by an object detection algorithm based on deep learning); Next, a distance from the vehicle body to the road marking may be estimated through an inverse perspective model (a step S302), and then the road marking identified from the complete road image I_{t-n, t} may be compared with road marking information in a map file provided by the map system 30 (a step S303). According to the distance obtained in the step S302, a comparison result of the road marking obtained in the step S303 and a potential location of the vehicle body provided by the global positioning system 40, an exact location of the vehicle body in the map file may be deduced and presented on a display unit 50 equipped on the vehicle body as a subsequence driving route planning reference to be viewed by the users. In other words, when the potential location and the road marking information in the map file corresponding to the road marking are both known, the location of the vehicle body may be positioned at a higher level than a global positioning system (GPS) positioning accuracy according to the vehicle positioning method of this embodiment. In the case where the GPS positioning accuracy is reduced or invalid (e.g. in a small alleyway with many surrounding buildings, or when the weather is bad), the road image reconstruction of the present embodiment can be used to reduce the influence caused by inaccurate GPS positioning and still accurately position the location of the vehicle body in the map file.

Here, it should be noted that, the application of the road image reconstruction method mentioned in this disclosure is not limited to the vehicle positioning, but can also be used to, for example, create a map database for all the road markings.

In summary, according to the embodiments of the disclosure, with the feature correspondences taken from the images at adjacent time points, those images may be stitched to generate the complete road image in which the road marking is not occluded. Further, in the road image reconstructed according to the embodiments of the disclosure, because the road marking is not occluded, the road marking detection and identification may be performed subsequently to assist in positioning or other possible applications.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

1. A road image reconstruction method, comprising:
a capturing step, capturing an image Iₜ₋ₙ at time t-n and an image Iₜ at time t, the image Iₜ₋ₙ at time t-n and the image Iₜ at time t including identical road surface pixels and different road surface pixels;
an analyzing step, analyzing the image Iₜ₋ₙ at time t-n and the image Iₜ at time t to obtain a plurality of feature correspondences;
an estimating step, estimating a geometric relationship between the image Iₜ₋ₙ at time t-n and the image Iₜ at time t from the feature correspondences; and
a stitching step, stitching the image Iₜ₋ₙ at time t-n and the image Iₜ at time t into a complete road image I_{t-n, t} according to the geometric relationship obtained in the estimating step, and distances between the identical road surface pixels and the different road surface pixels in the image Iₜ₋ₙ at time t-n and the image Iₜ at time t.

2. The road image reconstruction method according to claim 1, before the analyzing step, further comprising:
a segmenting step, segmenting the image Iₜ₋ₙ at time t-n and the image Iₜ at time t so that road surface pixels of a travelable region in the image Iₜ₋ₙ at time t-n and the image Iₜ at time t have a visual characteristic different from that of the other pixels.

3. The road image reconstruction method according to claim 1,
before the analyzing step, further comprising:
a transforming step, transforming the image Iₜ₋ₙ at time t-n and the image Iₜ at time t into bird view images.

4. The road image reconstruction method according to claim 1,
wherein the analyzing step comprises:
finding a plurality of features in the image Iₜ₋ₙ at time t-n and the image Iₜ at time t; and
comparing the features to verify the feature correspondences in the image Iₜ₋ₙ at time t-n and the image Iₜ at time t.

5. The road image reconstruction method according to claim 1, wherein the estimating step comprises:
defining a coordinate value of each of the feature correspondences at time t-n in the image Iₜ₋ₙ at time t-n as x;
defining a coordinate value of each of the feature correspondences at time t in the image Iₜ at time t as x′;
defining x′=Hx, wherein H is a 3×3 matrix, and the coordinate values are expressed as homogeneous coordinate values; and
solving the 3×3 matrix H by known coordinate values of the feature correspondences.

6. The road image reconstruction method according to claim 1, wherein the stitching step comprises:
defining a bottom border coordinate of the image Iₜ₋ₙ at time t-n as L_{t-n, btm};
defining a top border coordinate of the image Iₜ at time t as L_{t, top};
defining a stitch weight α as (y−L_{t, top})/(L_{t-n, btm}−L_{t, top}), wherein y denotes a coordinate of each of the road surface pixels in a Y direction; and
stitching the road surface pixels located between the bottom border coordinate L_{t-n, btm} and the top border coordinate L_{t, top} in the image Iₜ₋ₙ at time t-n and the image Iₜ at time t in a linear manner according to the stitch weight α, so as to generate the complete road image I_{t-n, t}, wherein a relationship between the image Iₜ₋ₙ at time t-n, the image Iₜ at time t, and the complete road image I_{t-n, t} is defined by I_{t-n, t}=αIₜ₋ₙ+(1−α) Iₜ.

7. A vehicle positioning method for positioning a vehicle equipped with an image capturing device, the vehicle positioning method comprising:
a capturing step, capturing an image Iₜ₋ₙ at time t-n and an image Iₜ at time t, the image Iₜ₋ₙ at time t-n and the image Iₜ at time t including identical road surface pixels and different road surface pixels;
an analyzing step, analyzing the image Iₜ₋ₙ at time t-n and the image Iₜ at time t to obtain a plurality of feature correspondences;
an estimating step, estimating a geometric relationship between the image Iₜ₋ₙ at time t-n and the image Iₜ at time t from the feature correspondences; and
a stitching step, stitching the image Iₜ₋ₙ at time t-n and the image Iₜ at time t into a complete road image I_{t-n, t} according to the geometric relationship obtained in the estimating step, and distances between the identical road surface pixels and the different road surface pixels in the image Iₜ₋ₙ at time t-n and the image Iₜ at time t;
an identifying step, detecting and identifying a road marking in the complete road image I_{t-n, t};
a measuring step, estimating a distance from the road marking to the vehicle;
a comparing step, comparing the road marking in the complete road image I_{t-n, t} with road marking information in a map file; and
a positioning step, deducing an exact location of the vehicle in the map file according to the distance obtained in the measuring step, a comparison result of the road marking obtained in the comparing step, and a potential location of the vehicle provided by a global positioning system.

8. A road image reconstruction system, comprising:
an image capturing device, capturing an image Iₜ₋ₙ at time t-n and an image Iₜ at time t, the image Iₜ₋ₙ at time t-n and the image Iₜ at time t including identical road surface pixels and different road surface pixels; and
a processing unit, executing steps including:
an analyzing step, analyzing the image Iₜ₋ₙ at time t-n and the image Iₜ at time t to obtain a plurality of feature correspondences;
an estimating step, estimating a geometric relationship between the image Iₜ₋ₙ at time t-n and the image Iₜ at time t from the feature correspondences; and
a stitching step, stitching the image Iₜ₋ₙ at time t-n and the image Iₜ at time t into a complete road image I_{t-n, t} according to the geometric relationship obtained in the estimating step, and distances between the identical road surface pixels and the different road surface pixels in the image Iₜ₋ₙ at time t-n and the image Iₜ at time t.

9. (canceled)
